(19) United States
(12) Patent Application Publication
(10) Pub. No.: US 2025/0232420 A1
(43) Pub. Date: Jul. 17, 2025

(54) TRUE COLOR IMAGE ENHANCEMENT COMPENSATION

(71) Applicant: VISTEON GLOBAL TECHNOLOGIES, INC., Van Buren Township, MI (US)

(72) Inventors: Paul Fredrick Luther Weindorf, Novi, MI (US); Brian John Hayden, Royal Oak, MI (US)

(73) Assignee: VISTEON GLOBAL TECHNOLOGIES, INC., Van Buren Township, MI (US)

(21) Appl. No.: 19/016,057

(22) Filed: Jan. 10, 2025

Related U.S. Application Data
(60) Provisional application No. 63/620,255, filed on Jan. 12, 2024.
(60) Provisional application No. 63/620,257, filed on Jan. 12, 2024.
(60) Provisional application No. 63/620,264, filed on Jan. 12, 2024.

(51) Int. Cl. G06T 5/92; G06T 5/40; G06T 7/90; G09G 3/20; G09G 3/34

(52) U.S. Cl. CPC G06T 5/92; G06T 5/40; G06T 7/90; G09G 3/2007; G06T 2207/10024; G06T 2207/20208; G09G 3/3406; G09G 2320/066; G09G 2320/0666; G09G 2320/0673; G09G 2360/16; G09G 2380/10

(57) ABSTRACT

A true color image enhancement system includes an ambient light sensor, a circuit and a processor. The ambient light sensor measures an ambient light level. The circuit generates a histogram based on an input video signal; and generates an output video signal by converting gray shades in the input video signal based on input video luminance ratios and a look up table to determine new output gray shade values to maintain input video color coordinates. The processor develops the look up table based on the histogram and the ambient light level; dynamically remaps the gray shades in the look up table in response to the ambient light signal to compress one region and stretch another region; dynamically remaps the gray shades in the look up table to correct for ambient lighting conditions; and transfers the look up table to the circuit.

### CROSS-REFERENCE TO RELATED APPLICATIONS

This application claims the benefit of U.S. Provisional Application Nos. 63/620,255 filed Jan. 12, 2024, 63/620,257 filed Jan. 12, 2024, and 63/620,264 filed Jan. 12, 2024, which are hereby incorporated by reference in their entirety.

### TECHNICAL FIELD

The present disclosure generally relates to systems and methods for vehicle display image enhancement.

### BACKGROUND

In automotive display applications, light sensors have been utilized to automatically control the display luminance as a function of the ambient lighting environment. As the ambient illumination increases, the display luminance increases to maintain visibility of the images. Automatic luminance control methods maintain a comfortable level of viewing brightness, and reduce a display power consumption as the ambient illumination decreases. Although automatic luminance control methods maintain visibility of the symbols for peak-white gray shades, the visibility of lower gray shades may be compromised.

### SUMMARY

A true color image enhancement compensation system is provided herein. The true color image enhancement compensation system includes an ambient light sensor, a circuit and a processor. The ambient light sensor is operational to measure an ambient light level. The circuit is operational to generate a histogram based on an input video signal, export the histogram, receive a gray shade look up table, and generate an output video signal by converting a plurality of gray shades in the input video signal based on a plurality of input video luminance ratios and the gray shade look up table to determine a plurality of new output gray shade values to maintain input video color coordinates. The processor is operational to: receive the histogram from the circuit, develop the gray shade look up table based on the histogram and the ambient light level, dynamically remap the plurality of gray shades in the gray shade look up table in response to the ambient light signal to compress a first region of the plurality of gray shades and stretch a second region of the plurality of gray shades, dynamically remap the plurality of gray shades in the gray shade look up table to correct for ambient lighting conditions, and transfer the gray shade look up table to the circuit.

A true color image enhancement compensation system is provided herein. The true color image enhancement compensation system includes an ambient light sensor, a circuit, and a processor. The ambient light sensor is operational to measure an ambient light level. The circuit is operational to generate a histogram based on an input video signal, export the histogram, receive a gray shade look up table, dynamically remap a plurality of gray shades in the gray shade look up table using a highest remapped color to determine and maintain a plurality of input luminance ratios of a plurality of lower gray shade colors, and generate an output video signal by converting a plurality of gray shades in the input video signal based on a plurality of input video luminance ratios and the gray shade look up table to determine a plurality of new output gray shade values to maintain input video color coordinates. The processor is operational to receive the histogram from the circuit, develop the gray shade look up table based on the histogram and the ambient light level, and transfer the gray shade look up table to the circuit.

A true color image enhancement compensation system is provided herein. The true color image enhancement compensation system includes an ambient light sensor, a circuit, and a processor. The ambient light sensor is operational to measure an ambient light level. The circuit is operational to generate a histogram based on an input video signal, export the histogram, receive a gray shade look up table, dynamically remap a plurality of gray shades in the gray shade look up table using a tristimulus conversion matrix to determine a plurality of normalized gray shades based on a normalization of a highest color when an upper limit is reached, and generate an output video signal by converting a plurality of gray shades in the input video signal based on a plurality of input video luminance ratios and the gray shade look up table to determine a plurality of new output gray shade values to maintain input video color coordinates. The processor is operational to receive the histogram from the circuit, develop the gray shade look up table based on the histogram and the ambient light level, and transfer the gray shade look up table to the circuit.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a platform.

FIG. 2 illustrates a graph of an image enhancement gray shade transfer function.

FIG. 3 illustrates a graph of an image enhancement transfer function.

FIG. 4 illustrates a graph of a normalized luminance transfer function.

FIG. 5 illustrates a graph of the 1931 CIE color chart.

FIG. 6 illustrates a graph of an orange icon color shift after image enhancement.

FIG. 7 illustrates a flow chart of an implementation of a 3-step alternative color correction method.

FIG. 8 illustrates a flow chart of an implementation of an 8-step tristimulus color correction method.

FIG. 9 illustrates a graph of an image enhancement transfer function.

FIG. 10 illustrates a graph of a dynamic adaptive image enhancement principle.

FIG. 11 illustrates an intermediate functional block diagram of a system.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a true color image enhancement compensation system. Where a gray shade transfer table is used to remap gray shades for image enhancement, an original color may not be maintained for secondary and tertiary colors. In various embodiments of the disclosure, the original image input colors are maintained after utilization with an image enhancement gray shade transfer table.

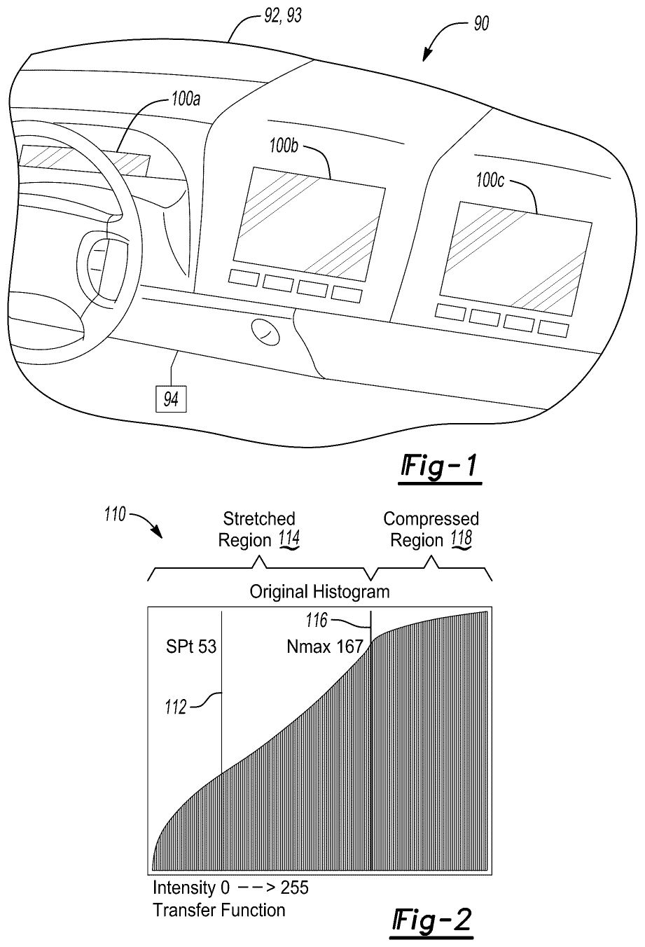

FIG. 1 illustrates a context of a platform 90 in accordance with one or more exemplary embodiments. The platform 90 generally includes an instrument panel 92. The instrument panel 92 includes a control unit 94 and one or more display panels 100a-100c. The instrument panel 92 may be implemented as part of a vehicle 93. The vehicle 93 may include mobile vehicles such as automobiles, trucks, motorcycles, boats, trains and/or aircraft. In some embodiments, the instrument panel 92 may be part of a stationary object. The stationary objects may include, but are not limited to, billboards, kiosks, and/or marquees. Other types of platforms 90 may be implemented to meet the design criteria of a particular application.

The control unit 94 implements one or more display-drive circuits. The control unit 94 is generally operational to generate control signals that drive the display panels 100a-100c. In various embodiments, the control signals may be configured to provide instrumentation (e.g., speed, tachometer, fuel, temperature, etc.) to at least one display panel 100a-100c (e.g., 100a). In some embodiments, the control signals may also be configured to provide video (e.g., a rear-view camera video, a forward-view camera video, an onboard DVD player, etc.) to the display panels 100a-100c. In other embodiments, the control signals may be further configured to provide alphanumeric information shown on one or more of the display panels 100a-100c.

In various embodiments, the control unit 94 generally comprises at least one microcontroller. The at least one microcontroller may include one or more processors, each of which may be embodied as a separate processor, an application specific integrated circuit (ASIC), a field programmable gate array (FPGA), or a dedicated electronic control unit.

The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry. The at least one microcontroller may be embedded as part of an FPGA or ASIC device.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components in the platform 90 and communicate instructions to the display panels 100a-100c through one or more control signals to control the displays panels 100a-100c.

The display panels 100a-100c are generally mounted to the instrument panel 92. In various embodiments, one or more of the display panels 100a-100c may be disposed inside the platform 90 (e.g., vehicle 93). In other embodiments, one or more of the display panels 100a-100c may be disposed exterior to the platform 90. One or more display panels 100a-100c may implement an active public/privacy viewing modes. One or more display panels 100a-100c may also implement the privacy mode. As illustrated, the display panel 100a may be a cluster display positioned for use by a driver. The display panel 100b may be a console display positioned for use by the driver and a passenger. The display panel 100c may be a passenger display positioned for use by the passenger and the driver.

### Introduction

Light sensors may be utilized to automatically control the display luminance as a function of the ambient lighting environment. As the ambient illumination increases as detected by the light sensor(s), the display luminance is increased to maintain visibility of the image. The automatic luminance control maintains a comfortable level of viewing brightness, and reduces the display power consumption as the ambient illumination decreases. Although automatic luminance control methods do maintain visibility of symbology for peak white video content, the visibility of lower video gray shade content may be compromised. More recently, image enhancement methods are becoming available that are capable of making the video content more visible to the user. However, these image enhancement methods may or may not improve the image in response to the ambient illumination level. The combination of automatic luminance control coupled with image enhancement adjustment as a function of the ambient illumination may be utilized provide a new product class that provides visibility of the entire image under all ambient lighting conditions, while at the same time reduces the overall power of the display system.

### Background

FIG. 2 illustrates a graph 110 of an example image enhancement gray shade transfer function in accordance with one or more exemplary embodiments. An issue with automatic luminance control is that the lower video gray shade content becomes less visible under reflected ambient lighting conditions and increasing the display luminance does little for lower video content visibility. An image enhancement function is used to change the shape of the video transfer function dynamically as a function of the ambient lighting conditions. The video transfer function as depicted in FIG. 2 has the input video gray shades on the x-axis and the output video gray shades are on the ordinate axis. Therefore, the input video gray shades are mapped to the output video gray shades as determined by the image enhancement transfer function. For example, if sunlight is shining on the display, the user may see a reflected background from the display commonly known as glare. The glare may make the lower video gray shades difficult to see since the glare is higher in luminance than the lower video gray shades. To make the lower gray shades visible, the lower gray shades (e.g., to the left of the line 116) may be mapped (e.g., stretched region 114) to higher output gray shades thereby increasing the lower gray shade luminance values and making them visible. Higher gray shades (e.g., to the right of an N_{Max} line 116 be mapped differently (e.g., compressed region 118). Due to the non-linear shape of the transfer function, ratios of the color mixtures may result in a color shift as the shape of the curve changes as a function of the ambient illumination level.

### Analysis

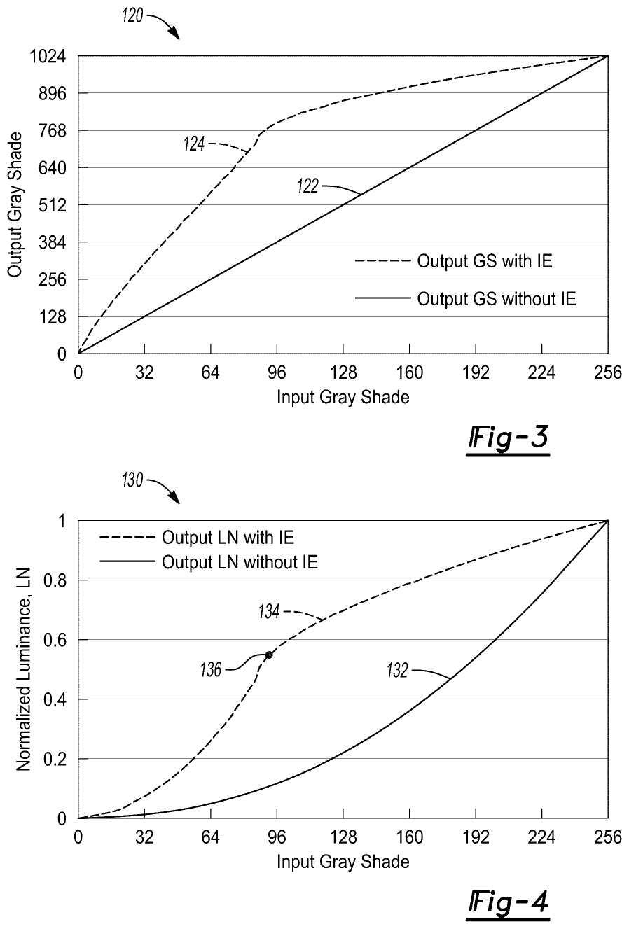

FIG. 3 illustrates a graph 120 of an example image enhancement transfer function in accordance with one or more exemplary embodiments. A curve 122 represents the output gray shades without image enhancement (IE). A curve 124 represents the output gray shades with the image enhancement.

FIG. 4 illustrates a graph 130 of an example normalized luminance transfer function in accordance with one or more exemplary embodiments. A curve 132 represents normalized luminance output without image enhancement (IE). A curve 134 represents normalized luminance output with the image enhancement. A point 136 may be a breakpoint.

Consider a test image that includes multiple colors and multiple icons. A color shift of an orange icon to yellow may be caused in an absence of color compensation (or correction) where a high degree of image enhancement is employed. Since the colors are determined by the mixture of the R, G, B luminance values, FIG. 3 may be converted to normalized luminance, LN, per FIG. 4 using Equation 1 with values of γ=2.2 and GS_{Max}=1023 (10 bit).

$${L}_{N} = {( \frac{G S}{G {S}_{Max}} )}^{γ} \qquad Eq . ( 1 )$$

Where:
γ is a gamma value.
GS is a gray-shade value.
GS_{MAX} is a maximum gray shade value.

Table 1 shows a comparison of the normalized luminance values with and without image enhancement for the orange color.

TABLE 1

| Color | Gray Shade | L_{N} w/o IE | L_{N} with IE |
|---|---|---|---|
| Red | 250 | 0.96 | 0.99 |
| Green | 102 | 0.13 | 0.60 |
| Blue | 0 | 0 | 0 |

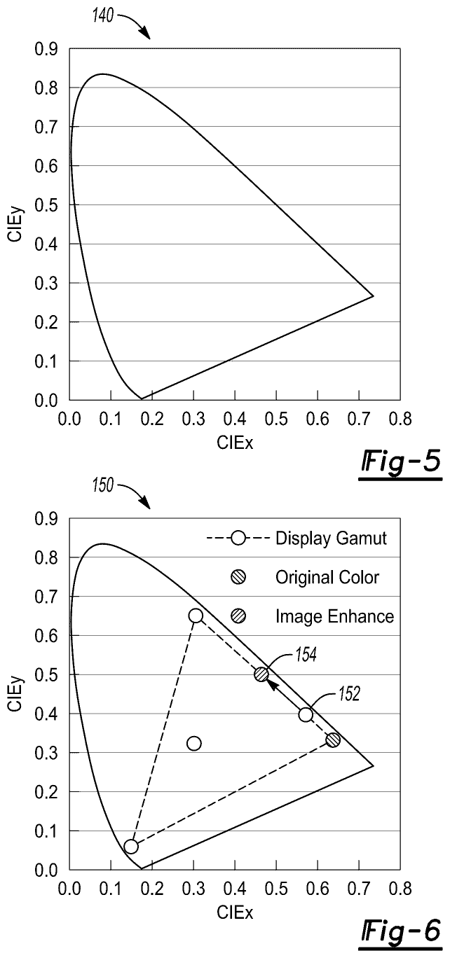

FIG. 5 illustrates a graph 140 of the 1931 CIE color chart in accordance with one or more exemplary embodiments. In Table 1, the ratio of red to green changes from 7.4 (0.96/0.13) without IE to 1.7 (0.99/0.60) with IE. Although the amount of red luminance stays relatively constant (0.96 to 0.99), the amount of green luminance increases (0.13 to 0.60) with image enhancement causing the orange color to become yellowish. As may be observed from the 1931 CIE color chart in FIG. 5, where as more green is mixed in, the color shifts from orange to yellow.

Returning to FIG. 4, note that before the breakpoint 136 (N_{Max}) in the image enhanced luminance curve 134, the curve 134 is essentially a gamma curve that may be expressed by Equation 2, as follows, where the offset gamma function is utilized instead of the constant contrast ratio function.

$${L}_{N} = {( \frac{G S}{G {S}_{Max}} )}^{γ} \qquad Eq . ( 2 )$$

Therefore, if there are two gray-shade levels GS₁ and GS₂ for two colors normalized luminances L_{N1} and L_{N2}, the formulas may be expressed as Equations 3 and 4 as follows:

$${L}_{N 1} = {( \frac{G {S}_{1}}{G {S}_{Max}} )}^{γ} \qquad Eq . ( 3 )$$

$${L}_{N 2} = {( \frac{G {S}_{2}}{G {S}_{Max}} )}^{γ} \qquad Eq . ( 4 )$$

A luminance ratio for the two color may be expressed by Equation 5 as follows:

$$Ratio = \frac{{L}_{N 2}}{{L}_{N 1}} = \frac{{( \frac{{GS}_{2}}{{GS}_{Max}} )}^{γ}}{{( \frac{{GS}_{1}}{{GS}_{Max}} )}^{γ}} = {( \frac{{GS}_{2}}{{GS}_{1}} )}^{γ} \qquad Eq . ( 5 )$$

Therefore, as the GS_{Max} and the maximum luminance changes as a function of the endpoint function, the luminance ratios may remain constant and therefore the corresponding color may not change. Where one, both, or all of the gray shades are above the break point, the luminance ratios and therefore the corresponding color changes. In the example, the orange color may not change where the values are Red=113, Green=44 and Blue=0. Since the Red value of 113 is just beyond the break point, the color remains largely unchanged even though the transfer function is changing dramatically.

Further analysis of an orange circular icon starts with sample display tristimulus values as shown in Table 2. The methods used to calculate color coordinates using the tristimulus values is described in “Color Space Conversions,” by A. Ford and A. Roberts, 1998, which is hereby incorporated by reference in its entirety.

TABLE 2
Tristimulus Values

| | Red | Green | Blue |
|---|---|---|---|
| X | 330.26 | 293.35 | 177.66 |
| Y | 172.27 | 622.85 | 69.7 |
| Z | 15.61 | 41.72 | 933.48 |

Using the tristimulus matrix, the resulting tristimulus X, Y and Z values may be determined from the normalized R, G, B values according to Equation 6 as follows:

$$\vert \begin{matrix}X \\ Y \\ Z\end{matrix} \vert = \vert \begin{matrix}330.26 & 293.35 & 177.66 \\ 172.27 & 622.85 & 69.7 \\ 15.61 & 41.72 & 933.48\end{matrix} \vert * \vert \begin{matrix}R \\ G \\ B\end{matrix} \vert \qquad Eq . ( 6 )$$

The R, G, B values in Equation 6 are the normalized luminance values calculated according to Equations 7, 8 and 9 as follows:

$$R = {( \frac{{GS}_{Red}}{{GS}_{Max}} )}^{γ} \qquad Eq . ( 7 )$$

$$G = {( \frac{{GS}_{Green}}{{GS}_{Max}} )}^{γ} \qquad Eq . ( 8 )$$

$$B = {( \frac{{GS}_{Blue}}{{GS}_{Max}} )}^{γ} \qquad Eq . ( 9 )$$

Where the orange icon values of GS_{Red}=250, GS_{Green}=102, and GS_{Blue}=0 and inserted into Equations 7, 8 and 9, the normalized luminance RGB values are determined per Equations 10, 11 and 12 as follows:

$$R = {( \frac{{GS}_{Red}}{{GS}_{Max}} )}^{γ} = {( \frac{250}{255} )}^{2.2} = 0.95737 \qquad Eq . ( 10 )$$

$$G = {( \frac{{GS}_{Green}}{{GS}_{Max}} )}^{γ} = {( \frac{102}{255} )}^{2.2} = 0.13321 \qquad Eq . ( 11 )$$

$$B = {( \frac{{GS}_{Blue}}{{GS}_{Max}} )}^{γ} = {( \frac{0}{255} )}^{2.2} = 0 \qquad Eq . ( 12 )$$

Using the tristimulus Equation 6, the X, Y, Z tristimulus values may be determined per Equation 13 as follows:

$$\vert \begin{matrix}X \\ Y \\ Z\end{matrix} \vert = \vert \begin{matrix}330.26 & 293.35 & 177.66 \\ 172.27 & 622.85 & 69.7 \\ 15.61 & 41.72 & 933.48\end{matrix} \vert * \vert \begin{matrix}0.95737 \\ 0.13321 \\ 0\end{matrix} \vert \qquad Eq . ( 13 )$$

$$\vert \begin{matrix}X \\ Y \\ Z\end{matrix} \vert = \vert \begin{matrix}355.2576 \\ 247.895 \\ 20.502\end{matrix} \vert$$

The tristimulus values determined in Equation 13 may then be used to calculate the 1931 CIE x,y color coordinates per Equations 14 and 15, as follows:

$$x = \frac{X}{X + Y + Z} = \frac{355.2576}{355.2576 + 247.895 + 20.502} \qquad Eq . ( 14 )$$

$$x = 0.57$$

$$y = \frac{Y}{X + Y + Z} = \frac{247.895}{355.2576 + 247.895 + 20.502} \qquad Eq . ( 15 )$$

$$y = 0.4$$

Therefore, the input image color coordinates for the orange icon are (x,y)=(0.57,0.40).

After the image enhancement transfer function is applied to the input gray-shade values, the output values are:
GS_{Red}=1018.3 (10 bit)
GS_{Green}=810.862 (10 bit)
GS_{Blue}=0

Using these values, the new normalized luminance values may be determined per Equations 16, 17 and 18 as follows:

$${R}_{N} = {( \frac{{GS}_{Red}}{{GS}_{Max}} )}^{γ} = {( \frac{1018.3}{1023} )}^{2.2} = 0.98992 \qquad Eq . ( 16 )$$

$${G}_{N} = {( \frac{{GS}_{Green}}{{GS}_{Max}} )}^{γ} = {( \frac{810.862}{1023} )}^{2.2} = 0.59971 \qquad Eq . ( 17 )$$

$${B}_{N} = {( \frac{{GS}_{Blue}}{{GS}_{Max}} )}^{γ} = {( \frac{0}{1023} )}^{2.2} = 0 \qquad Eq . ( 18 )$$

Using the tristimulus matrix, the X, Y, Z tristimulus values may be determined per Equation 19 as follows:

$$\vert \begin{matrix}X \\ Y \\ Z\end{matrix} \vert = \vert \begin{matrix}330.26 & 293.35 & 177.66 \\ 172.27 & 622.85 & 69.7 \\ 15.61 & 41.72 & 933.48\end{matrix} \vert * \vert \begin{matrix}0.98992 \\ 0.59971 \\ 0\end{matrix} \vert \qquad Eq . ( 19 )$$

$$\vert \begin{matrix}X \\ Y \\ Z\end{matrix} \vert = \vert \begin{matrix}502.8552 \\ 544.0612 \\ 40.4724\end{matrix} \vert$$

As was done previously, the 1931 CIE x,y color coordinate values may be determined per Equations 20 and 21 as follows:

$$x = \frac{X}{X + Y + Z} = \frac{502.8552}{502.8552 + 544.0612 + 40.4724} \qquad Eq . ( 20 )$$

$$x = 0.46$$

$$y = \frac{Y}{X + Y + Z} = \frac{544.0612}{502.8552 + 544.0612 + 40.4724} \qquad Eq . ( 21 )$$

$$y = 0.5$$

FIG. 6 illustrates a graph 150 of an example orange icon color shift after image enhancement in accordance with one or more exemplary embodiments. After the image enhancement transfer function is applied the (x,y) values changes from (x,y)=(0.57,0.40) 152 to (0.46,0.50) 154. This change in color is shown in the CIE color chart per FIG. 6 as illustrated.

### Image Recommendations

In certain display technologies, namely adaptive image processing, significant use of colors that are not primary colors or secondary colors (or close to) may present unusual effects when the image enhancement transfer function is applied. Use of such colors where the ratio of R, G, B is >1.5:1 may be limited (e.g., not used in a prominent way) if any of the RGB gray shades exceed 64. Color mixtures with RGB values less than 64 in any ratio generally do not present the unusual effects.

ISO 15008:2017 Table B.1 provides guidance for symbol/background color combinations.

TABLE B.1

| Background | Symbol Color | | | | | | |
|---|---|---|---|---|---|---|---|
| Color | White | Yellow | Orange | Red^{a}, Purple | Green, Cyan | Blue^{a}, Violet | Black |
| White | | − | 0 | + | + | ++ | ++ |
| Yellow | − | | − | 0 | 0 | + | ++ |
| Orange | 0 | − | | − | − | 0 | + |
| Red^{a}, Purple | + | 0 | − | | − | − | + |
| Green, Cyan | + | 0 | − | − | | − | + |
| Blue^{a}, Voilet | ++ | + | 0 | − | − | | − |
| Black | ++ | ++ | + | + | + | − | |

++ Preferred
+ Recommended
0 Acceptable with high saturation differences
− Not recommended
^{a}Pure red and blue should be avoided in view of the fact that the eyes may have trouble focusing on these colors because of eye chromatic aberration.

### Alternate Pixel-by-Pixel Image Enhancement Color Correction Method

To realize a more color robust image enhancement technique, a pixel-by-pixel color correction is performed. By operating on the video stream on a pixel-by-pixel basis, memory allocation sized to hold a full video frame may be avoided, resulting in a cost effective FPGA solution. An alternate color correction method has some small color shifts that may not be noticeable due to the way the image enhancement technique works by compressing the upper gray shades. White or colors with balanced gray shades may not be affected by using this alternate color correction method. The alternate color correction method uses less computations than tristimulus matrix methods and may be implemented with a current image enhancement FPGA architecture.

The alternate color correction method is based on the following proof and is fundamentally based on the “Power of a Fraction Rule” shown in Table 3.

TABLE 3
Rules of Exponents or Laws of Exponents

| | |
|---|---|
| Multiplication Rule | a^{x} × a^{y} = a^{x+y} |
| Division Rule | a^{x} ÷ a^{y} = a^{x+y} |
| Power of a Power Rule | (a^{x})^{y} = a^{xy} |
| Power of a Product Rule | (ab)^{x} = a^{x}b^{x} |
| Power of a Fraction Rule | (a/b)^{x} = a^{x}/b^{x} |
| Zero Exponent | a⁰ = 1 |

An aspect of the color correction method is understanding the concept that color is based on RGB luminance ratios. If the luminance ratios remain constant, the colors may remain constant.

A minimalistic proof starts with the luminance formulas for red, green, and blue as shown in Equations 22, 23 and 24, as follows, respectively, for 8-bit video.

$${L}_{R} = {{L}_{maxR} ( \frac{{GS}_{R}}{255} )}^{γ} \qquad Eq . ( 22 )$$

$${L}_{G} = {{L}_{maxG} ( \frac{{GS}_{G}}{255} )}^{γ} \qquad Eq . ( 23 )$$

$${L}_{B} = {{L}_{maxB} ( \frac{{GS}_{B}}{255} )}^{γ} \qquad Eq . ( 24 )$$

The maximum input gray shades are transformed into the maximum output gray shades due the monotonic nature of the image enhancement transfer function. Consider a case where the input gray shades GS_{Rin}, GS_{Gin}, GS_{Bin} are transformed to output gray shades GS_{Rout}, GS_{Gout}, GS_{Bout}. Also suppose that the red input has the maximum gray-shade value, GS_{Rinmax}. Therefore, GS_{Rinmax}=GS_{Rin}. The color correction may be accomplished by using Equations 25, 26 and 27 as follows:

$${GS}_{Rout} = {GS}_{Rin} ( \frac{{GS}_{Rout}}{{GS}_{Rinmax}} ) = {GS}_{Rout} \qquad Eq . ( 25 )$$

$${GS}_{Gout} = {GS}_{Gin} ( \frac{{GS}_{Rout}}{{GS}_{Rinmax}} ) \qquad Eq . ( 26 )$$

$${GS}_{Bout} = {GS}_{Bin} ( \frac{{GS}_{Rout}}{{GS}_{Rinmax}} ) \qquad Eq . ( 27 )$$

This approach disregards the original non-maximum GS_{Gout} and GS_{Bout} values, then replaces these values with the new values per Equations 26 and 27 above.

If the red to green luminance ratio is to be determined, the original input gray-shade luminance ratios may be determined using Equations 22 and 23 per Equation 28 as follows:

$$\frac{{L}_{Rin}}{{L}_{Gin}} = \frac{{{L}_{maxR} ( \frac{{GS}_{Rin}}{255} )}^{γ}}{{{L}_{maxG} ( \frac{{GS}_{Gin}}{255} )}^{γ}} \qquad Eq . ( 28 )$$

Using the “Power of a Fraction Rule” per Table 3, Equation 28 may be converted into Equation 29 as follows:

$$\frac{{L}_{Rin}}{{L}_{Gin}} = \frac{{L}_{maxR} [ \frac{{( {GS}_{Rin} )}^{γ}}{{( 255 )}^{γ}} ]}{{L}_{maxG} [ \frac{{( {GS}_{Gin} )}^{γ}}{{( 255 )}^{γ}} ]} \qquad Eq . ( 29 )$$

The “255” terms in Equation 29 may be cancelled out resulting in Equation 30 as follows:

$$\frac{{L}_{Rin}}{{L}_{Gin}} = \frac{{{L}_{maxR} ( {GS}_{Rin} )}^{γ}}{{{L}_{maxG} ( {GS}_{Gin} )}^{γ}} = \frac{{L}_{maxR}}{{L}_{maxG}} {( \frac{{GS}_{Rin}}{{GS}_{Gin}} )}^{γ} \qquad Eq . ( 30 )$$

In a similar fashion, the red to green luminance ratios may be determined using the output results from Equations 25 and 26. Starting with the gamma function, Equation 31 may be constructed as follows:

$$\frac{{L}_{Rout}}{{L}_{Gout}} = \frac{{{L}_{maxR} ( \frac{{GS}_{Rout}}{255} )}^{γ}}{{{L}_{maxG} ( \frac{{GS}_{Gout}}{255} )}^{γ}} \qquad Eq . ( 31 )$$

The “255” terms in Equation 31 may once again be cancelled out resulting in Equation 32 as follows:

$$\frac{{L}_{Rout}}{{L}_{Gout}} = \frac{{{L}_{maxR} ( {GS}_{Rout} )}^{ℽ}}{{{L}_{maxG} ( {GS}_{Gout} )}^{ℽ}} = \frac{{L}_{maxR}}{{L}_{maxG}} {( \frac{{GS}_{Rout}}{{GS}_{Gout}} )}^{ℽ} \qquad Eq . ( 32 )$$

Equations 25 and 26 may then be substituted into Equation 32 resulting in Equation 33 as follows:

$$\frac{{L}_{Rout}}{{L}_{Gout}} = \frac{{L}_{maxR}}{{L}_{maxG}} {( \frac{{GS}_{Rin} ( \frac{{GS}_{Rout}}{{GS}_{Rinmax}} )}{{GS}_{Gin} ( \frac{{GS}_{Rout}}{{GS}_{Rinmax}} )} )}^{ℽ} \qquad Eq . ( 33 )$$

Cancelling like terms in Equation 33 yields Equation 34, as follows, which matches the input luminance ratio in Equation 30.

$$\frac{{L}_{Rout}}{{L}_{Gout}} = \frac{{L}_{maxR}}{{L}_{maxG}} {( \frac{{GS}_{Rin}}{{GS}_{Gin}} )}^{ℽ} \qquad Eq . ( 34 )$$

### Image Simulation

To confirm the pixel-by-pixel image enhancement color correction method, image processing was employed. The procedure used was: 1) extract the RGB gray-shade values from a test image; 2) implement the prescribed equations and method within a spreadsheet and 3) transformation of the data back to an image file to provide the graphical confirmation of the results. In order to operate with a reasonable spreadsheet file size, the input test image was cropped to 300×300 pixels. The cropping thus limits the processing within the spreadsheet to 300×900 RGB gray-shade values.

The RGB gray-shade values of the test image were extracted using an image editing program, ImageJ (National Institute of Health, Bethesda, Maryland) by saving the image as a “Text Image”. The text file containing the RGB gray-shade values was then imported into the spreadsheet for data processing. The following process was implemented as formula within spreadsheet taking into account the appropriate fixed-point mathematics and data truncation. This allows the pixel-by-pixel implementation and calculates the output RGB gray scale values for each of the 300×300 input pixels. After saving the results as a text file, the results were transformed back to a color corrected image file using the ImageJ software. The corrected image file showed perceptible gray-shade enhancements with imperceptible color shifting.

### FPGA Implementation Recommendations

To simplify the color conversion mathematics for a FPGA, the basic premise is to use fixed-point numbers and to avoid fractional numbers. The use of lookup tables is encouraged.

The alternate color correction method may be summarized by starting with Equations 35, 36 and 37, as follows:

$${GS}_{Rout} = {GS}_{Rin} ( \frac{{GS}_{maxout}}{{GS}_{maxin}} ) \qquad Eq . ( 35 )$$

$${GS}_{Gout} = {GS}_{Gin} ( \frac{{GS}_{maxout}}{{GS}_{maxin}} ) \qquad Eq . ( 36 )$$

$${GS}_{Bout} = {GS}_{Bin} ( \frac{{GS}_{maxout}}{{GS}_{maxin}} ) \qquad Eq . ( 37 )$$

Where:
GSₘₐₓᵢₙ is the maximum gray shade of the RGB input gray shades.
GSₘₐₓₒᵤₜ is the maximum gray shade of the RGB output gray shades using the transfer table.

The maximum gray shade on the output may always be associated with the same color component for the maximum input gray shade.

Since GSₘₐₓᵢₙ may match one of the GS_{RGBin} gray-shade values, only two of the three equations could be determined. Since division is difficult in an FPGA, one method is to construct a table of 255 multiplier Mₘₐₓᵢₙ values per Equation 38 as follows:

$${M}_{maxin} = \frac{{2}^{16}}{{GS}_{maxin}} \qquad Eq . ( 38 )$$

Since 2¹⁶ divided by 1 may be represented with 2 bytes, the table may take 3-bytes×256=6,144 bits of memory. For GSₘₐₓᵢₙ=0, the output from the lookup table gray shade may be set to zero to avoid division by zero singularity in Equation 38. In addition, the lookup table value for GSₘₐₓᵢₙ=1 may be set to 2¹⁶−1 (65,535) to fit into 2 bytes. The 2¹⁶ multiplication improves the accuracy of the results without resorting to floating point multiplication.

The multiplication may be done in 34-bit fixed-point mathematics. Using the multiplier table concept, Equations 35, 36 and 37, are transformed into Equations 39, 40, and 41 as follows:

$${GS}_{Rout} \times {2}^{16} = {GS}_{Rin} {GS}_{maxout} {M}_{maxin} \qquad Eq . ( 39 )$$

$${GS}_{Gout} \times {2}^{16} = {GS}_{Gin} {GS}_{maxout} {M}_{maxin} \qquad Eq . ( 40 )$$

$${GS}_{Bout} \times {2}^{16} = {GS}_{Bin} {GS}_{maxout} {M}_{maxin} \qquad Eq . ( 41 )$$

Alternative forms of Equations 39, 40, and 41 are shown by Equations 42, 43, and 44, respectively, as follows:

$${GS}_{Rout} = \frac{{GS}_{Rin} {GS}_{maxout} {M}_{maxin}}{{2}^{16}} \qquad Eq . ( 42 )$$

$${GS}_{Gout} = \frac{{GS}_{Gin} {GS}_{maxout} {M}_{maxin}}{{2}^{16}} \qquad Eq . ( 43 )$$

$${GS}_{Bout} = \frac{{GS}_{Bin} {GS}_{maxout} {M}_{maxin}}{{2}^{16}} \qquad Eq . ( 44 )$$

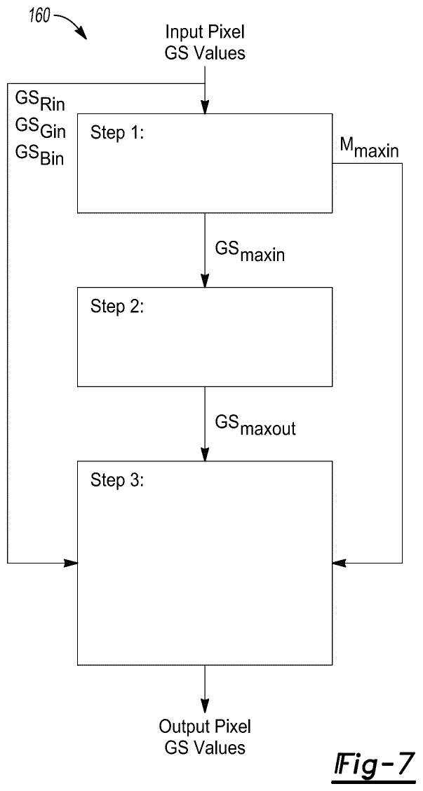

FIG. 7 illustrates a flow chart 160 of an example implementation of a 3-step alternative color correction method in accordance with one or more exemplary embodiments. The alternative color correction method may be implemented in an FPGA.

The data flow for the video pixel stream is to process each pixel in real time and send the modified RGB gray scale values for processing by the FRC function or directly to the TDMS converter depending on the options selected. There are 3 basic steps. The goal is to implement the mathematics in fixed 32-bit binary using multiplication and a 16-bit right shift. In addition, a lookup table is used to determine one of the three multiplier values. A mechanism is provided to ensure that the output video timing for the in-line pixel processing remains constant.

Step 1: Find the Gray Shade maximum input value, GSₘₐₓᵢₙ, from Input RI, GI, BI Values and Lookup Multiplier Mₘₐₓᵢₙ using GSₘₐₓᵢₙ.

The first step consists of two parts. First, the maximum value of the red, green, and blue gray shades of the incoming pixel is determined as a gray scale maximum input value GSₘₐₓᵢₙ. This gray shade maximum input value is then used to lookup the multiplier value using a lookup table that consists of multiple (e.g., 256) entries according to the Equation 38. Each output from the table is 16 bits and therefore every table entry is 3 bytes for a total table size of 3×8×256=6144. Note that for GSₘₐₓᵢₙ=0, the output from the lookup table shade may be set to zero to avoid division by zero in Equation 38. In addition, the lookup table value for GSₘₐₓᵢₙ=1 is set to 216-1 (65535) to fit into 2 bytes.

Step 2: Use GSₘₐₓᵢₙ to Lookup GSₘₐₓₒᵤₜ using Transfer Function Table.

The step 2 uses GSₘₐₓᵢₙ from step 1 to lookup a gray scale maximum output value GSₘₐₓₒᵤₜ using the transfer function uploaded from a source (e.g., a processor external to the FPGA) via an SPI or another suitable digital interface. GSₘₐₓₒᵤₜ may be a 10-bit value ranging from 0 to 1023.

Step 3: Calculate GS_{Rout}, GS_{Gout}, GS_{Bout}

Calculate gray scale output values GS_{Rout}, GS_{Gout}, and GS_{Bout} using Equations 45, 46 and 47 as follows:

$${GS}_{Rout} = \frac{{GS}_{Rin} {GS}_{maxout} {M}_{maxin}}{{2}^{16}} \qquad Eq . ( 45 )$$

$${GS}_{Gout} = \frac{{GS}_{Gin} {GS}_{maxout} {M}_{maxin}}{{2}^{16}} \qquad Eq . ( 46 )$$

$${GS}_{Bout} = \frac{{GS}_{Bin} {GS}_{maxout} {M}_{maxin}}{{2}^{16}} \qquad Eq . ( 47 )$$

The numerator may be calculated prior to the 16-bit right shift division to maintain the accuracy of the results. Before the 16-bit right shift division, the product of the numerator may use a storage size of 34 bits.

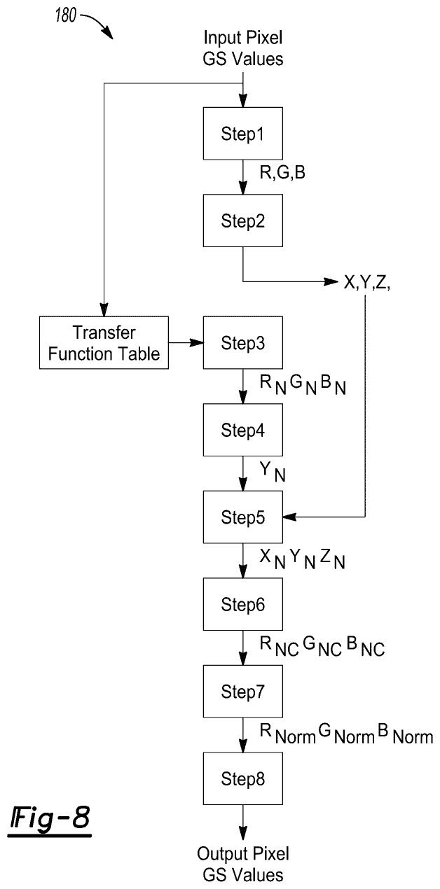

FIG. 8 illustrates a flow chart 180 of an example implementation of an 8-step tristimulus color correction method in accordance with one or more exemplary embodiments. The tristimulus color correction method (or calculations) may be implemented in an FPGA. A comparison of example implementations of two methods shows that the 3-step alternative color correction method involves different computations and FPGA resources than the 8-step tristimulus color correction method.

Step 1: Convert the Input Pixel Gray Shade Values to R_{I}, G_{I}, B_{I} Values.

A lookup table is used to convert the input pixel gray shade values to R_{I}, G_{I}, and B_{I} values which are proportional to luminance values. An example equation may be

$${R}_{I} , {G}_{I} , {B}_{I} = {( \frac{GS}{255} )}^{2.2} .$$

Step 2: Convert the R_{I}, G_{I}, B_{I} Values to X_{I}, Y_{I}, and Z_{I} Values Using a Tristimulus Conversion Matrix.

The R_{I}, G_{I}, B_{I} values are converted to the X_{I}, Y_{I}, and Z_{I} values using a proportional tristimulus conversion matrix. The conversion matrix is received from the microprocessor via the SPI or another suitable digital interface. An example of the conversion matrix is shown in Equation 48 as follows:

$$[ \begin{matrix}{X}_{I} \\ {Y}_{I} \\ {Z}_{I}\end{matrix} ] = [ \begin{matrix}0 C 38 & 0 ADB & 0693 \\ 0660 & 170 C & 0294 \\ 0094 & 018 B & 228 A\end{matrix} ] * [ \begin{matrix}{R}_{I} \\ {G}_{I} \\ {B}_{I}\end{matrix} ] \qquad Eq . ( 48 )$$

The mathematics may be done in 32-bit fixed point format.

Step 3: Convert the Transfer Function Gray Shade Values into First Intermediate Values R_{N}, G_{N}, B_{N}.

The input pixel gray shade values are first converted to new gray shade values GS_{NRed}, GS_{NGreen}, and GS_{NBlue} using the transfer table that is uploaded from the microprocessor to the FPGA via the SPI port on a periodic (e.g., 60 Hz) update rate. The new gray shade values from the transfer table are then used to lookup the R_{N}, G_{N}, B_{N} values using another lookup table.

### Step 4: Calculate Second Intermediate Value Y_{N}.

Calculate the second intermediate value Y_{N} using the same conversion matrix used in Step 2 as shown in Equation 49 as follows:

$$[ \begin{matrix}{X}_{N} \\ {Y}_{N} \\ {Z}_{N}\end{matrix} ] = [ \begin{matrix}0 C 38 & 0 ADB & 0693 \\ 0660 & 170 C & 0294 \\ 0094 & 018 B & 228 A\end{matrix} ] * [ \begin{matrix}{R}_{N} \\ {G}_{N} \\ {B}_{N}\end{matrix} ] \qquad Eq . ( 49 )$$

The value of Y_{N} alone may be calculated. X_{N} and Z_{N} are calculated in Step 5. Shift the results (bit-shift right, e.g., divide by 2″) by the number of bits from the lookup table. Use the sum of the input pixel gray shade R, G, B (e.g., R+G+B) values to determine the number of bits to shift. Discard the bits that fall off the right side.

Step 5: Calculate Second Intermediate Values X_{N} and Z_{N}.

Calculate the second intermediate values X_{N} and Z_{N} using Equations 50 and 51 as follows. Multiply the numerators first and then divide by Y_{I} (discarding the remainder).

$${X}_{N} = \frac{{Y}_{N} {X}_{I}}{{Y}_{I}} \qquad Eq . ( 50 )$$

$${Z}_{N} = \frac{{Y}_{N} {Z}_{I}}{{Y}_{I}} \qquad Eq . ( 51 )$$

If Y_{I}=0, set X_{N} and Z_{N} to zero.

Step 6: Calculate Third Intermediate Value R_{NC}, G_{NC}, and B_{NC} Using Inverse Matrix.

Use the inverse matrix uploaded from the microprocessor via the SPI port to calculate the third intermediate values R_{NC}, G_{NC}, and B_{NC} using Equation 52 as follows:

$$[ \begin{matrix}{R}_{NC} \\ {G}_{NC} \\ {B}_{NC}\end{matrix} ] = [ \begin{matrix}6 F 5 F & CCB 6 & EEA 2 \\ E 140 & 3 AD 1 & 0176 \\ FF 83 & FE 3 B & 1 DDF\end{matrix} ] * [ \begin{matrix}{X}_{N} \\ {Y}_{N} \\ {Z}_{N}\end{matrix} ] \qquad Eq . ( 52 )$$

Inverse Matrix values may be represented as 2's complement values to account for negative numbers.

Shift the results (bit-shift right, e.g., divide by 2″) by the number of bits from the lookup table. Use the sum of the input pixel gray shade R, G, B (e.g., R+G+B) values to determine the number of bits to shift. First, implement the additions and then perform the subtractions. If a resultant value is negative, set the result to zero.

Step 7: Normalize R_{NC}, G_{NC}, B_{NC} Values to R_{Norm}, G_{Norm}, and B_{Norm}.

If any of the R_{NC}, G_{NC}, and/or B_{NC} values are >196965, use Equations 53, 54 and 55, as follows, to calculate the normalized values R_{Norm}, G_{Norm}, and B_{Norm}. First divide by 16, discarding the remainders. Next multiply the numerators. Finally divide by the denominator, discarding the remainders. Note that the highest R_{NC}, G_{NC}, B_{NC} value will result in 196965 and therefore that calculation shall be avoided.

$${R}_{Norm} = \frac{( \frac{{R}_{NC}}{16} ) * 196965}{\{ ( \frac{Highest of {R}_{NC} , {G}_{NC} , {B}_{NC}}{16} ) \}} \qquad Eq . ( 53 )$$

$${G}_{Norm} = \frac{( \frac{{G}_{NC}}{16} ) * 196965}{\{ ( \frac{Highest of {R}_{NC} , {G}_{NC} , {B}_{NC}}{16} ) \}} \qquad Eq . ( 54 )$$

$${B}_{Norm} = \frac{( \frac{{B}_{NC}}{16} ) * 196965}{\{ ( \frac{Highest of {R}_{NC} , {G}_{NC} , {B}_{NC}}{16} ) \}} \qquad Eq . ( 55 )$$

If none of the results for R_{NC}, G_{NC}, or B_{NC}>196965, Equations 56, 57, and 58 may be utilized. Otherwise:

$${R}_{Norm} = {R}_{NC} \qquad Eq . ( 56 )$$

$${G}_{Norm} = {G}_{NC} \qquad Eq . ( 57 )$$

$${B}_{Norm} = {B}_{NC} \qquad Eq . ( 58 )$$

Step 8: Convert R_{Norm}, G_{Norm}, and B_{Norm} to GS_{NRed}, GS_{NGreen}, GS_{NBlue}

Use an additional table in a reverse order to look up the GS_{NRed}, GS_{NGreen}, and GS_{NBlue} values that are then sent to a frame rate control (FRC) function or directly to the TMDS converter (bypass mode).

As a numeric example, the original orange icon case had input gray-shade values according to Equations 39, 40, and 41 with:
GS_{Rin}=250;
GS_{Gin}=102; and
GS_{Bin}=0.

The output values after the image enhancement transfer function were:
GS_{Rout}=1018;
GS_{Gout}=811; and
GS_{Bout}=0.

Using the alternate method, the multiplier, Mₘₐₓᵢₙ, may be determined from the lookup table with a value per Equation 59 as follows:

$${M}_{maxin} = \frac{{2}^{16}}{{GS}_{maxin}} = \frac{{2}^{16}}{250} = 262 \qquad Eq . ( 59 )$$

Using Equations 39, 40, and 41 results in Equations 60, 61, and 62 as

$${GS}_{Rout} \times {2}^{16} = 250 \times 1018 \times 262 = 66679000 \qquad Eq . ( 60 )$$

$${GS}_{Gout} \times {2}^{16} = 102 \times 1018 \times 262 = 27205 \; 032 \qquad Eq . ( 61 )$$

$${GS}_{Bout} \times {2}^{16} = 0 \times 1018 \times 262 = 0 \qquad Eq . ( 62 )$$

Due to the 2¹⁶ multiplication embedded in the Mₘₐₓᵢₙ multiplier, the values in Equation 59, 60, and 61 are divided by 216 to produce the following results:
GS_{Rout}=1017;
GS_{Gout}=415; and
GS_{Bout}=0.

The tristimulus color correction method produces the following results:
GS_{Rout}=1023;
GS_{Gout}=417; and
GS_{Bout}=0.

An implementation of the FPGA may include six multiplications and two 16-bit right shifts. The equation associated with the maximum value may not be computed because two terms cancel each other and the original value is obtained.

Although the output luminance is a bit lower by this alternate method, the output color is correct. This method is simple to implement, and the resulting luminance variations are imperceptible.

From a luminance aspect, the current transfer function methods may not produce the correct luminance for any color that does not have equal RGB gray shades. Luminance for white is correctly produced, and luminance is also correctly produced for any secondary color where two of the gray shades are matched and one gray shade is zero. All other color mixtures generally do not follow the intended Fechner curves. Other more complex methods may be implemented to accomplish this goal. As an example, the orange icon has input gray shades according to GS_{Rin}=250, GS_{Gin}=102, and GS_{Bin}=0. To study the luminance effects, one method is to convert pixel color gray shades to equivalent monochrome gray shade. The use of equivalent monochrome gray shades allows observation of what the image enhancement transfer function should have produced from a luminance aspect. To convert the orange icon to a monochrome gray-shade value, Equation 63, as follows, may be utilized where the coefficients are based on the sample tristimulus luminance data as recorded in Table 2.

$${GS}_{M} = {[ \frac{{L}_{R}}{{L}_{m ax}} {( {GS}_{R} )}^{γ} + \frac{{L}_{G}}{{L}_{m ax}} {( {GS}_{G} )}^{γ} + \frac{{L}_{B}}{{L}_{m ax}} {( {GS}_{B} )}^{γ} ]}^{( 1 / γ )} \qquad Eq . ( 63 )$$

GS_{M} in Equation 60 is the equivalent monochrome gray shade that provides the display luminance when used with Equation 64 as follows:

$$L = {{L}_{m ax} ( \frac{{GS}_{M}}{{GS}_{m ax}} )}^{γ} \qquad Eq . ( 64 )$$

By substituting Equation 63 into Equation 64, Equation 65, as follows, may be used to prove that Equation 62 is correct.

$$L = {{L}_{m ax} ( \frac{{[ \frac{{{L}_{R} ( {GS}_{R} )}^{γ}}{{L}_{m ax}} + \frac{{{L}_{G} ( {GS}_{G} )}^{γ}}{{L}_{m ax}} + \frac{{{L}_{B} ( {GS}_{B} )}^{γ}}{{L}_{m ax}} ]}^{( 1 / γ )}}{{GS}_{m ax}} )}^{γ} \qquad Eq . ( 65 )$$

Using the “Power of a Fraction Rule” per Table 3, Equation 65 may be manipulated to reveal Equation 66 as follows:

$$L = {L}_{ma x} ( \frac{{( {[ \frac{{{L}_{R} ( {GS}_{R} )}^{γ}}{{L}_{m ax}} + \frac{{{L}_{G} ( {GS}_{G} )}^{γ}}{{L}_{m ax}} + \frac{{{L}_{B} ( {GS}_{B} )}^{γ}}{{L}_{m ax}} ]}^{( 1 / γ )} )}^{γ}}{{( {GS}_{ma x} )}^{γ}} ) \qquad Eq . ( 66 )$$

Next the “Power of a Power Rule” may be employed to simplify Equation 66 into Equation 67 as follows:

$$L = {L}_{m ax} ( \frac{\frac{{{L}_{R} ( {GS}_{R} )}^{γ}}{{L}_{m ax}} + \frac{{{L}_{G} ( {GS}_{G} )}^{γ}}{{L}_{m ax}} + \frac{{{L}_{B} ( {GS}_{B} )}^{γ}}{{L}_{m ax}}}{{( {GS}_{m ax} )}^{γ}} ) \qquad Eq . ( 67 )$$

The Lₘₐₓ terms in Equation 67 may be cancelled thereby yielding Equation 68 as follows:

$$L = \frac{{{L}_{R} ( {GS}_{R} )}^{γ} + {{L}_{G} ( {GS}_{G} )}^{γ} + {{L}_{B} ( {GS}_{B} )}^{γ}}{{( {GS}_{m ax} )}^{γ}} \qquad Eq . ( 68 )$$

Using the distributive law, Equation 68 may be rewritten as Equation 69 as follows:

$$L = \frac{{{L}_{R} ( {GS}_{R} )}^{γ}}{{( {GS}_{m ax} )}^{γ}} + \frac{{{L}_{G} ( {GS}_{G} )}^{γ}}{{( {GS}_{m ax} )}^{γ}} + \frac{{{L}_{B} ( {GS}_{B} )}^{γ}}{{( {GS}_{m ax} )}^{γ}} \qquad Eq . ( 69 )$$

Finally, the “Power of a Fraction Rule” per Table 3 may be used to yield Equation 70 as follows:

$$L = {{L}_{R} ( \frac{{GS}_{R}}{{GS}_{m ax}} )}^{γ} + {{L}_{G} ( \frac{{GS}_{G}}{{GS}_{m ax}} )}^{γ} + {{L}_{B} ( \frac{{GS}_{B}}{{GS}_{m ax}} )}^{γ} \qquad Eq . ( 70 )$$

The coefficients in Equation 63 are derived by using the “Y” row values of Table 2 per Equations 71, 72, and 73 as follows:

$${R}_{C} = \frac{172.27}{172.27 + 622.85 + 69.7} = 0 \text{.199} \qquad Eq . ( 71 )$$

$${G}_{C} = \frac{622.85}{172.27 + 622.85 + 69.7} = 0.7 \; 20 \qquad Eq . ( 72 )$$

$${B}_{C} = \frac{69.7}{172.27 + 622.85 + 69.7} = 0.081 \qquad Eq . ( 73 )$$

Inserting these coefficients into Equation 63, results in Equation 74 as follows:

$${GS}_{M} = {[ 0.199 {( {GS}_{R} )}^{γ} + 0.72 {( {GS}_{G} )}^{γ} + 0.081 {( {GS}_{B} )}^{γ} ]}^{( 1 / γ )} \qquad Eq . ( 74 )$$

Substituting the icon input RGB gray-shade values GS_{Rin}=250, GS_{Gin}=102, and GS_{Bin}=0 in Equation 74 produces Equation 75 as follows:

$${GS}_{M} = {[ 0.199 {( 250 )}^{2.2} + 0.72 {( 102 )}^{2.2} + 0.081 {( 0 )}^{2.2} ]}^{( 1 / 2.2 )} \qquad Eq . ( 75 )$$

Performing the calculation in Equation 75 shows that the equivalent monochrome gray shade is 144.

The luminance associated with gray shade 144 may be determined using Equation 64 with Lₘₐₓ=864.82, as shown in Equation 76 as follows:

$$L = 864.82 {( \frac{144}{255} )}^{2.2} = 246 nits \qquad Eq . ( 76 )$$

Note that Lₘₐₓ is the summation of the “Y” row terms in the tristimulus matrix Table 2.

In the uncompensated image enhancement lookup table method, where the icon color transitioned from orange to yellow, the new gray-shade values where GS_{Rout}=1018, GS_{Gout}=811 and GS_{Bout}=0. The equivalent monochrome 10-bit gray shade for the yellow icon may be determined using Equation 74 as shown with numeric values per Equation 77 as follows:

$$\begin{matrix}{GS}_{M} = {[ 0.199 {( 1018 )}^{2.2} + 0.72 {( 811 )}^{2.2} + 0.081 {( 0 )}^{2.2} ]}^{( 1 / 2.2 )} \\ {GS}_{M} = 829\end{matrix} \qquad Eq . ( 77 )$$

The luminance associated with 10-bit monochrome gray shade 829 may be determined according to Equation 78 as follows:

$$L = 864.82 {( \frac{829}{1023} )}^{2.2} = 545 nits \qquad Eq . ( 78 )$$

The equivalent monochrome gray shade (GS_{M}) for the tristimulus based gray shades GS_{Rout}=1023, GS_{Gout}=417, and GS_{Bout}=0 is calculated per Equation 79 as follows:

$$G {S}_{M} = {[ 0.199 {( 1023 )}^{2.2} + 0.72 {( 417 )}^{2.2} + 0.081 {( 0 )}^{2.2} ]}^{( 1 / 2.2 )} G {S}_{M} = 591 \qquad Eq . ( 79 )$$

The luminance associated with 10-bit monochrome gray shade 591 may be determined according to Equation 80 as follows:

$$L = 864.82 {( \frac{591}{1023} )}^{2.2} = 259 nits \qquad Eq . ( 80 )$$

The alternate color correction method produced gray-shade values according to Equations 60, 61, and 62 with the resulting monochrome gray shade per Equation 81.

$$G {S}_{M} = {[ 0.199 {( 1017 )}^{2.2} + 0.72 {( 415 )}^{2.2} + 0.081 {( 0 )}^{2.2} ]}^{( 1 / 2.2 )} G {S}_{M} = 588 \qquad Eq . ( 81 )$$

The luminance associated with 10-bit monochrome gray shade 588 may be determined according to Equation 82 as follows:

$$L = 864.82 {( \frac{588}{1023} )}^{2.2} = 256 nits \qquad Eq . ( 82 )$$

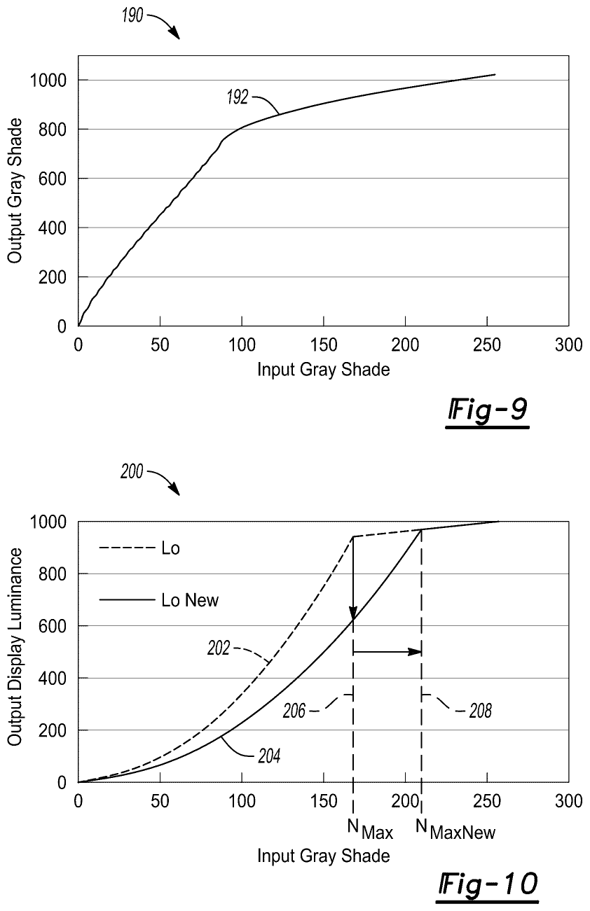

FIG. 9 illustrates a graph 190 of an example image enhancement transfer function 192 in accordance with one or more exemplary embodiments. Notice that although the alternate color correction method may not provide the maximum possible orange luminance, the value is close due to the fact that the red color is in the upper compression zone of the transfer function 192 as depicted in FIG. 9.

The original transfer function method is based on obtaining the desired luminance based on the Burnette Fechner curves. For the color white, which has equal RGB gray-shade values, the desired output luminance is obtained using the transfer function. However, for secondary colors like orange that do not have equal gray-shade values, the correct luminance may not be obtained. As an example, a monochrome input gray shade for the orange icon was determined to be a value of 144 per Equation 61 above. If the value of 144 is used in conjunction with the transfer function per FIG. 9, the desired output luminance would be gray shade 894 that would translate into 642 nits using Equation 83 as follows:

$$L = 864.82 {( \frac{894}{1023} )}^{2.2} = 642 nits \qquad Eq . ( 83 )$$

However, this luminance may not be realizable because the red luminance suitable to obtain overall luminance of 642 nits may be beyond what the display is capable of supplying and therefore the luminance is scaled back to maintain the orange color. The reason that the orange icon turns yellow is because the input red gray shade of 250 is in the upper compression zone, while the green gray shade of 102 is just coming out of the “linear” zone with a different slope. Therefore, since one of the gray shades is in the upper compression gray shades, it is already near the maximum value and therefore this is one of the reasons that the alternate color method may be utilized and causes little difference in the results when compared to the more computation intensive tristimulus color correction method. Table 4 is a summary of the results.

TABLE 4
Summary for Input GS (R, G, B) = (250, 102, 0)

| Configuration | GS_{M} | Luminance (Nits) | Color |
|---|---|---|---|
| Input | 144 (8-bit) | 246 | Orange |
| | (578 10-bit) | | |
| No Color | 829 (10-bit) | 545 | Yellow |
| Correction | | | |
| Tristimulus Color | 591 (10-bit) | 259 (bounded | Orange |
| Correction | | by max red GS) | |
| Alternate Color | 588 (10-bit) | 256 | Orange |
| Correction | | | |

Table 4 shows that there is a negligible difference in the final luminance value for the alternate color correction method versus the tristimulus color correction method. Therefore, the use of the alternate color correction method has minimal effect of the results due to the nature of the monotonic compression of the upper gray shades.

The second aspect of the alternate color correction method is that the curve below the compression zone is mostly linear in nature while the offset gamma function is used. For example, suppose the color orange has a red gray-shade value of 75 below the compression break point. The corresponding green gray-shade value may be determined according to Equation 84 as follows:

$$G {S}_{G} = \frac{102}{250} 75 = 31 \qquad Eq . ( 84 )$$

These three values may represent the input orange gray-shade value of (75,31,0).

The image enhancement transfer function before color correction would convert the 8-bit values of (75,31,0) to 10-bit values of (639,302,0). This results in an equivalent monochrome gray shade of 389 according to Equation 85 as follows:

$$G {S}_{M} = {[ 0.199 {( 639 )}^{2.2} + 0.72 {( 302 )}^{2.2} + 0.081 {( 0 )}^{2.2} ]}^{( 1 / 2.2 )} G {S}_{M} = 389 \qquad Eq . ( 85 )$$

The monochromic gray shade of 389 results in a luminance value of 103 nits according to Equation 86 as follows:

$$L = 864.82 {( \frac{389}{1023} )}^{2.2} = 103 nits \qquad Eq . ( 86 )$$

Using the alternate color correction method, the new output gray shades may be determined according to Equations 87, 88, and 89 as follows:

$$G {S}_{R o u t} = 75 ( \frac{639}{75} ) = 639 \qquad Eq . ( 87 )$$

$$G {S}_{G o u t} = 31 ( \frac{639}{75} ) = 264 \qquad Eq . ( 88 )$$

$$G {S}_{B o u t} = 0 ( \frac{639}{75} ) = 0 \qquad Eq . ( 89 )$$

The equivalent monochrome gray-shade value is calculated per Equation 90 as follows:

$$G {S}_{M} = {[ 0.199 {( 639 )}^{2.2} + 0.72 {( 264 )}^{2.2} + 0.081 {( 0 )}^{2.2} ]}^{( 1 / 2.2 )} G {S}_{M} = 371 \qquad Eq . ( 90 )$$

The gray shade of 371 results in a luminance value of 93 nits according to Equation 91 as follows:

$$L = 864.82 {( \frac{371}{1023} )}^{2.2} = 93 nits \qquad Eq . ( 91 )$$

In summary, the tristimulus color correction method may have corrected the color with an output luminance of 103 nits compared to the alternate color correction method that yield 93 nits. Both methods produce the correct orange color coordinate. The difference of 93 nits compared with 103 nits is generally not noticeable. In addition, the correct Burnette transfer function may have taken the equivalent monochrome gray calculated by Equation 92 as follows:

$$G {S}_{M} = {[ 0.199 {( 75 )}^{2.2} + 0.72 {( 31 )}^{2.2} + 0.081 {( 0 )}^{2.2} ]}^{( 1 / 2.2 )} G {S}_{M} = 44 \qquad Eq . ( 92 )$$

The input luminance may be determined according to Equation 93 as follows:

$$L = 864.82 {( \frac{44}{255} )}^{2.2} = 18 nits \qquad Eq . ( 93 )$$

The image enhancement transfer function converts the gray shade 44 to a 10-bit gray-shade value of 404 resulting in a luminance of 112 nits per Equation 94 as follows:

$$L = 864.82 {( \frac{404}{1023} )}^{2.2} = 112 nits \qquad Eq . ( 94 )$$

The original color correction method and alternate color correction method produce reasonably close values to the intended luminance, and the differences may not be noticeable. A summary is presented in Table 5. Although there is a 20% decrease in luminance for the alternate color correction method from the ideal case, the decrease may not be noticed due to the counter measure of the Helmholtz effect.

TABLE 5
Summary for Input GS (R, G, B) = (75, 31, 0)

| Configuration | GS_{M} | Luminance (Nits) | Color |
|---|---|---|---|
| Input | 44 (8-bit) | 18 | Orange |
| | (177 10-bit) | | |
| No Color | 389 (10-bit) | 103 | |
| Correction | | | |
| Tristimulus Color | 389 (10-bit) | 103 | Orange |
| Correction | | | |
| Alternate Color | 371 (10-bit) | 93 | Orange |
| Correction | | | |
| Exact Solution | 404 (10-bit) | 112 | Orange |

The tristimulus color correction method may be improved by converting the input gray shades to a monochrome gray shade and then applying the transfer function to the input monochrome gray shade to obtain the desired output luminance value. The desired output luminance value may then be used to derive the correct color coordinates (purest mind set). By implementing the alternate color correction method, the FPGA calculations and resources are reduced, and a 90% solution is obtained that may not be noticeable by the user from the exact solution.

### Test Image Simulation Comparison

FIG. 10 illustrates a graph 200 of an example dynamic Adaptive Image Enhancement (AIE) principle in accordance with one or more exemplary embodiments. An original luminance output L_{O} (curve 202) may be shifted to a new luminance output L_{ONew} (curve 204). An original breakpoint N_{Max} (line 206) may be shifted to a new breakpoint N_{MaxNew} (line 208).

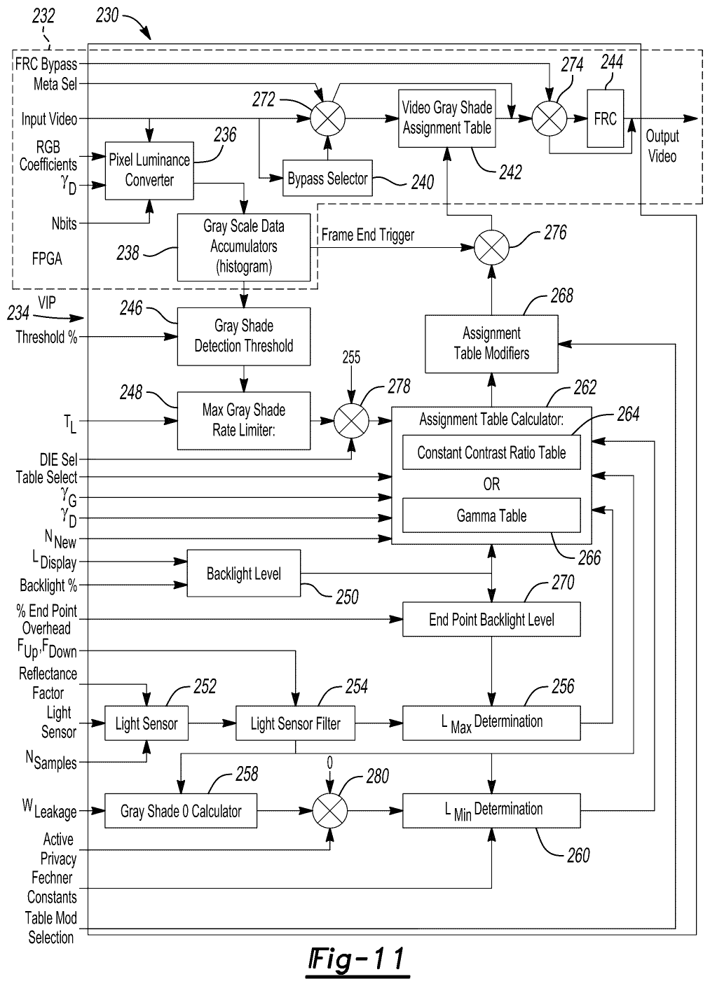

FIG. 11 illustrates an example intermediate functional block diagram 230 of a system in accordance with one or more exemplary embodiments.

In various embodiments, the diagram 230 may be implemented with a field programmable gate array (FPGA) or application specific integrated circuit (ASIC) 232 connected to a vehicle interface processor (VIP) 234 or other processor. Each of the blocks in the diagram are described as follows:

### Pixel Luminance Converter Block 236:

The pixel luminance converter block 236 converts every RGB pixel into a monochrome gray shade value based on Equation 95 where the RGB coefficients are (0.19, 0.68, 0.13).

$${( \frac{G {S}_{M}}{G {S}_{Max}} )}^{γ} = 0.19 {( \frac{G {S}_{R}}{G {S}_{Max}} )}^{γ} + 0.68 {( \frac{G {S}_{G}}{G {S}_{Max}} )}^{γ} + 0.13 {( \frac{G {S}_{B}}{G {S}_{Max}} )}^{γ} \qquad Eq . ( 95 )$$

Cancelling terms and solving for the equivalent monochrome gray shade results in Equation 96.

$$G {S}_{M} = {[ 0.19 {( G {S}_{R} )}^{γ} + 0.68 {( G {S}_{G} )}^{γ} + 0.13 {( G {S}_{B} )}^{γ} ]}^{( \frac{1}{γ} )} \qquad Eq . ( 96 )$$

### Gray Scale Data Accumulators Block 238:

Each pixel is converted into a monochrome gray scale value per Equation 101 and a value of 1 is added for each pixel to each corresponding gray scale accumulator consisting of GS_{Max} accumulators for each frame. For 8-bit video, this would use 256 accumulators. Histogram data is sent to the vehicle interface processor 234 at the end of each video frame. In addition, a Frame End Trigger (FET) is sent to the vehicle interface processor 234 indicating that the accumulators are ready to be down loaded to the vehicle interface processor 234. In addition, the frame end trigger is used to trigger the uploading of the AIE-LVE assignment table in preparation for the next frame of video conversion. Finally, the frame end trigger is used to signal that the new light sensor data is to be sampled. The light sensor sampling generally occurs once per frame cycle such that all functions used the same filtered data LBG light sensor data for each frame.

### Metadata AIE-LVE Bypass Selector Block 240:

The function of bypass selector block 240 is to use the metadata embedded in the video stream to determine safety related or other video symbols to which the AIE-LVE enhancement is not to be applied. In this case, the AIE-LVE assignment table is not utilized and the video for the areas are sent directly to the display.

### Video Gray Shade Assignment Table Block 242:

The gray shade assignment table block 242 utilizes the AIE-LVE assignment table to convert the incoming video gray shade values into the enhanced video gray shade values. Table 1 is an example of a video look up table that is uploaded by the FPGA or ASIC 232 during the video vertical blanking time in preparation for the next active video time period. The output from the gray scale assignment table may be either 10-bit video or 11-bit video.

### 10-Bit or 11-Bit Frame Rate Control Block 244:

The frame rate control block 244 applies frame rate control (FRC) methods to convert the 10-bit (or 11-bit) video data (high-dynamic range video) to dithered 8-bit video.

### Gray Shade Detection Threshold Determination Block 246:

The gray shade detection threshold determination block 246 determines the maximum gray scale number such that a specific percentage of the pixels are above a threshold percentage according to Equation 97. Therefore, the method starts at a highest accumulator and keeps adding the next lower accumulator value until the threshold percentage is determined for the corresponding gray shade value. This is the GS_{Max} N value used for stretching the dynamic video range after being filtered into variable N_{Max} by the rate limiting filter per block 248.

$$If [ \frac{SUM ( N : {N}_{Max} )}{SUM ( 0 : {N}_{Max} )} > \frac{{T}_{0 / 0}}{100} , {GS}_{Max} = N ] \qquad Eq . ( 97 )$$

### Max Gray Shade Filter Block 248:

The filter block 248 is a rate limiter whereby the N_{Max} value in incremented or decremented by one gray shade value (8 bit) towards the GS_{Max} value each TL time increment. The rate of the filter is set by the TL time increment input.

### Backlight Level Block 250:

A commanded backlight pulse width modulation (PWM) level is obtained and used to determine the display luminance, L_{DMax}, per Equation 98 as follows, where LD is the display luminance at 100% backlight drive, % BL.

$${L}_{DMax} = {\%}_{B L} \times {L}_{D} \qquad Eq . ( 98 )$$

### Light Sensor Pre-Filter Block 252:

In response to the Frame End Trigger (FET), N samples of the light sensor are successively measured and averaged resulting in the variable L_{BGNew} per Equation 99 as follows:

$${L}_{B G N e w} = {R}_{F} \times A V G ( {N}_{S amples} ) \qquad Eq . ( 99 )$$

Note that the reflectance factor, R_{F}, is used to determine how much of the light sensor value is reflected to the user and also to do any conversion to user observed nits.

### Light Sensor Filter Block 254:

The light sensor value obtained in block 252 is further filtered according to Equation 100 to obtain a faster exponential rise time of about 1 second than the fall time of about 60 seconds to mimic the eye adaptation times of the human visual system and to provide a peak detector function for the picket fence effects.

$${L}_{B G} = \frac{{L}_{B G N e w} + ( F - 1 ) {L}_{B GOld}}{F} \qquad Eq . ( 100 )$$

The F values are selected to be F_{Up} when the new light sensor value, L_{BGNew} is larger than the previous filtered value, L_{BGOld}, and F_{Down} where the new light sensor value, L_{BGNew} is smaller than the previous filtered value, L_{BGOld}. The time constant for the filter is selected for the 1 second rise time and 60 second fall time goal.

### L_{Max} Determination Block 256:

The user observed maximum luminance is determined per Equation 101, as follows, and is the summation of the end point display luminance (reference block 270) and the reflected background luminance, LBG, that the user sees.

$${L}_{Max} = {L}_{DLimit} + {L}_{B G} \qquad Eq . ( 101 )$$

L_{Max} is the higher end point for Equation 109 or Equation 110.

### Gray Shade 0 Calculator Block 258:

Gray shade 0 (GS₀) needs to be handled as a special case. If there is no active privacy function on the display, GS₀ is set to 0 nits to obtain the appearance of a black display where no information is present. If the display does have the privacy function active, the GS₀ background luminance may be raised to reduce the contrast ratio of the image. In various embodiments, the Weber Fraction level may be less than 25 for low black luminance values.

The Weber Fraction is the amount of white crosstalk that the driver sees when observing the passenger display. The “Fraction” is the amount of white luminance seen divided by the black luminance that the driver sees as formulated per Equation 102 as follows:

$${W}_{F} = \frac{{W}_{L e a k a g e}}{{L}_{G S 0} + {L}_{B G}} < 25 \qquad Eq . ( 102 )$$

Where:
W_{Leakage}=the amount of white leakage that the user sees;
L_{GS0}=the amount of display black luminance; and
L_{BG}=the amount of reflected background luminance that the user sees at night.

Equation 102 may be rearranged to yield Equation 103, as follows, that determines how much the display black luminance value may be increased to obtain a Weber Fraction of less than 25.

$${L}_{G S 0} > \frac{{W}_{L e a k a g e}}{25} {L}_{B G} \qquad Eq . ( 103 )$$

For proper operation in the formula for L_{Min}, L_{BG} is added to the display luminance to obtain L_{Min}. Therefore, to meet the Weber Fraction criteria, L_{Min} may be determined per Equation 104 as follows:

$${L}_{Min} > \frac{{W}_{L e a k a g e}}{25} \qquad Eq . ( 104 )$$

Such a AIE-LVE implementation provides that the black level luminance, L_{GS0}, may be increased to meet the Weber Fraction requirement.

### L_{Min} Determination Block 260:

A minimum luminance level for the assignment table calculation is based on the larger of the Weber Fraction black luminance level calculated per Equation 105 or the minimum luminance level calculated for display visibility per Equation 106 as follows:

$${L}_{Min} = \frac{{W}_{L e a k a g e}}{25} \qquad Eq . ( 105 )$$

$${L}_{Min} = {{B}_{O} ( {L}_{B G} )}^{C} + {L}_{B G} \qquad Eq . ( 106 )$$

The Fechner offset B_{O} and slope c constants are used together with the background luminance, L_{BG}, to determine the minimum luminance, L_{Min}, that the user needs to barely perceive the lowest gray shade information values. L_{Min} is the lower end point for Equation 109 or Equation 110. The minimum Fechner constant value may be calculated per Equation 107 as follows:

$${L}_{MinFechner} = {{B}_{O} ( {L}_{B G} )}^{C} + {L}_{B G} \qquad Eq . ( 107 )$$

### Assignment Table Calculator Block 262:

The assignment table calculation may have two parts. A first part is the calculation for the “black” level GS0 per Equation 108 as follows:

$$G {S}_{0} = ( {2}^{{N}_{N e w}} - 1 ) {{L}_{DMax}^{( - 1 / {γ}_{D} )} [ [ {L}_{G S 0} ] ]}^{( \frac{1}{{γ}_{D}} )} \qquad Eq . ( 108 )$$

A second calculation involves first choosing which assignment table calculation method may be utilized based on the “Table Select” command.
1. Constant Contrast Ratio Assignment Table 264; or
2. Gamma Assignment Table 266.

### Constant Contrast Ratio Assignment Table 264:

The process of calculating the intermediate input video gray shade values GS₁ through GS_{NMax} between L_{Min} and L_{Max} such that each successive gray shade has the same contrast ratio taking the reflected ambient into account the reflected ambient per Equation 109 as follows:

$$G {S}_{N} = ( {2}^{{N}_{N e w}} - 1 ) {{L}_{DMax}^{( - 1 / {γ}_{D} )} [ {{[ {L}_{Max} ]}^{( \frac{N - 1}{{N}_{Max} - 1} )} [ {L}_{Min} ]}^{( \frac{{N}_{Max} - N}{{N}_{Max} - 1} )} - {L}_{B G} ]}^{( \frac{1}{{γ}_{D}} )} \qquad Eq . ( 109 )$$

Gamma Assignment Table 266: The process of calculating the intermediate input video gray shade values

GS₁ through GS_{NMax} between L_{Min} and L_{Max} such that each of the gray shades follow an offset gamma function are determined according to Equation 110 as follows:

$${GS}_{N} = ( {2}^{{N}_{N e w}} - 1 ) {{L}_{DMax}^{( - 1 / {γ}_{D} )} [ ( {L}_{Max} - {L}_{Min} ) {( \frac{N}{{N}_{Max}} )}^{{γ}_{G}} + ( {L}_{Min} - {L}_{B G} ) ]}^{( \frac{1}{{γ}_{D}} )} \qquad Eq . ( 110 )$$

### Assignment Table Modifiers Block 268:

Block 268 provides an assignment table developed per Block 262 and is modified by multiplying other shaping functions.

### End Point Backlight Level Block 270:

Block 270 provides some overhead luminance that may be used in conjunction with AIE. If AIE is not used, or no overhead is desired, the input variable “% End Point Overhead” is set to zero. The end point modifier function in Block 270 may be activated if the “% End Point Overhead” is not zero.

### Selector S1, Metadata Control:

The selector S1 block 272 has two functions. If the metadata control is activated, the metadata is used to either bypass the AIE-LVE video assignment table or use the assignment table as a function of the metadata. If the metadata control is deactivated, the assignment table is used for all video data.

### Selector S2, FRC Bypass Control:

The selector S2 block 274 controls whether the Frame Rate Control function is utilized. If the display has a native 10-bit or 11-bit video input, the FRC function may be bypassed.

### Selector S3, Assignment Table Upload Control:

The selector S3 block 276 is triggered to upload the video assignment table as a function of the Frame End Trigger (FET) emanating from the FPGA (or ASIC) when the last video pixel for the current frame has been received. The video assignment table is to be uploaded during the video vertical blanking time in preparation for the next frame.

### Selector S4, AIE Activation Control:

The selector S4 block 278 control activates the AIE stretching function. If AIE stretching is not activated, N_{Max} is set to 255 and therefore all input gray shades (e.g., 0-255) are formulated to have a constant contrast ratio or gamma offset between L_{Min} and L_{Max}. If however the AIE stretching function is activated, N_{Max} is set according to the filtered video accumulator threshold per Blocks 246 and 248.

### Selector S5, Active Privacy Control:

The selector S5 block 280 control is utilized to activate raising the black gray shade 0 luminance, L_{GS0}, to a level required to meet the Weber Fraction criteria. This has the effect of raising the black level for both the driver and the passenger. Since the black level luminance, L_{GS0}, is a function of the (ambient) light sensor determined background luminance, L_{BG}, per Equation 108, as the reflected background luminance increases towards daylight conditions, the black level luminance, L_{GS0}, is decreased such that under daytime conditions the black gray shade luminance is not increased.

### VIP and FPGA Input List and Description:

Table 4 is a tabulation of the various inputs to the AIE-LVE software (or code). The variables may be stored in a Variable Control Register (VCR) that may be changed via a controller area network (CAN) bus or other communication methods.

TABLE 4
VIP Input List Description

| I.D. | Name | Description |
|---|---|---|
| 0 | Threshold % | % of upper gray shade |
| | | pixels that are not stretched |
| | | by AIE. The range for this |
| | | variable is 0% to 30% with a |
| | | typical value of 5%. |
| 1 | T_{L} | GS_{Max} rate limiter ΔT. |
| | | This is the time between |
| | | Incrementing or decrementing |
| | | the N_{Max} towards GS_{Max}. |
| | | This time will be in the range |
| | | of 10 ms to 100 ms. The |
| | | default value should be 10 ms |
| 2 | AE Sel | Enables or disables AIE |
| | | stretching function. |
| | | 0 = Disable and N_{Max} is set to 255. |
| | | 1 = Enable. The default |
| | | value should be 1. |
| 3 | γ_{D} | This is the gamma value |
| | | for the display which is |
| | | normally 2.2. The range for |
| | | this gamma will be from 1 |
| | | to 3 with two decimal points. |
| | | The default value should be 2.2. |
| 4 | N_{New} | This is the number of bits |
| | | for the output of the assignment |
| | | table calculator (normally 10 or |
| | | 11). The selection should be 8, |
| | | 10, 11 or 12 bits. The default |
| | | value should be 8 bits. |
| 5 | L_{Display} | Specifies the target display |
| | | luminance to the algorithm. |
| | | The range of this variable |
| | | will be 500 to 1500 nits with |
| | | 1000 nits as the default value. |
| 6 | Backlight % | Specifies the backlight PWM |
| | | % commanded to the display. |
| | | This variable will range from |
| | | 0% to 100% with 100% being the |
| | | default value. |
| 7 | F_{Up} | Filter Up weighting number. For a |
| | | 16.67 ms frame loop time, the |
| | | factor will be 32 for a 10% to |
| | | 90% time of 1.2 seconds. |
| | | The range should be 16 to 64 |
| | | with increments of 16 with the |
| | | default value of 32. |
| 8 | F_{Down} | Filter Down weighting number. For a |
| | | 16.67 ms frame loop time, the |
| | | factor will be 2048 for a 90% |
| | | to 10% time of 75 seconds. |
| | | The range should be 256 |
| | | to 2304 with increments of 256 |
| | | with the default value of 2048. |
| 9 | Reflectance | Display reflectance factor used |
| | Factor | with light sensor input to |
| | | determine the reflected |
| | | luminance that the user sees in |
| | | nit units. The range of the |
| | | reflectance should be 0.005 |
| | | to 0.100 with 3 decimal places |
| | | and a default value of 0.01. |
| 10 | Light Sensor | Light sensor input in Lux |
| | | units. This input will range |
| | | from 1 lux to 100K lux with |
| | | a default value of 5K lux. |
| 11 | N_{Samples} | Number of samples to be |
| | | averaged by the pre-filter. This |
| | | number can range from 4 to |
| | | 32 by increments of 4 |
| | | and a default value of 16. |
| 12 | W_{Leakage} | The amount of white leakage |
| | | that the driver sees in privacy |
| | | mode. The amount can range from |
| | | 0.1 to 10 nits with a default |
| | | value of 0.75 nits. |
| 13 | Active | Conveys active privacy mode |
| | Privacy | to algorithm. 0 = No Privacy. |
| | | 1 = Active Privacy. Default is 0. |
| 14 | Fechner | Offset B_{O} constant in nits. |
| | Constants | Slope Constant c. These constants |
| | | are used to determine the |
| | | minimum viewing luminance as a |
| | | function of the light sensor |
| | | input and reflectance factor. |
| | | The offset constant B_{O} will |
| | | range from 1 to 100 with a |
| | | default value of 11. Use 1 |
| | | decimal place. The slope |
| | | constant “c” will range from |
| | | 0.1 to 0.5 with a default value |
| | | of 0.273 (3 decimal places). |
| 15 | Table Mod | Selects which table modification |
| | Selection | functions are activated. |
| 16 | Table Mod | (not shown in Block diagram) |
| | Upload | Allows uploading of tables. |
| 17 | % End Point | This is the percentage of |
| | Overhead | the maximum display |
| | | luminance that is specified to |
| | | use for input gray shade |
| | | levels that are above the |
| | | threshold. The percentage |
| | | should range from 0 to 50%. |
| 18 | Table Select | Selects either between the |
| | | Constant Contrast Ratio |
| | | Assignment Table (Table |
| | | Select = 1, default) or the |
| | | Gamma Assignment Table |
| | | (Table Select = 1) |
| s19 | γ_{G} | This is the gamma value |
| | | for the gamma function |
| | | assignment table which is |
| | | normally 2.2. The range for |
| | | this gamma will be from |
| | | 0.5 to 3 with two decimal |
| | | points. The default value |
| | | should be 2.2. |
| 20 | Modifiers | This will be an 8 bit word that |
| | | controls invocation of modifier |
| | | functions. |
| | | Bit 0: M0 = 0 (No Modifiers), |
| | | 1 (Modifiers) |
| | | Bit 1: M1 = 0 (No Mod), 1 (End |
| | | Modifier) |
| | | Bit 2: M2 = 0 (No Mod), 1 (IPM |
| | | Modifier) |
| | | Bit 3: M3 = 0 (No Mod), 1 |
| | | (Gamma Modifier) |
| | | Bits 4-7: M4 = 0 (No Mod), 1 |
| | | (Reserved) |
| 21 | M1 Inputs | End Point Modifier Function: |
| | | “% End Point Overhead” |
| | | input is used to allocate how |
| | | much luminance is allocated for |
| | | the input gray shades that are |
| | | greater than the threshold. |
| 22 | M2 Inputs | Inflection Point Modifier (IPM) |
| | | Function: |
| | | A1 = Gain of 1^{st} phase which |
| | | can range from −0.5 to +0.5 |
| | | with a default value of 0. |
| | | A2 = Gain of 2^{nd} phase which |
| | | can range from −0.5 to +0.5 |
| | | with a default value of 0. |
| | | N_{I} = Input gray shade |
| | | inflection number. |
| 23 | M3 Inputs | Gamma Modifier Function: |
| | | γ_{M} = −0.9 to 3 with a default |
| | | value of 0.5. |

The methodology of how much the stretching should be decreased as the ambient light level is lowered, is complex and many possible solutions exist. In various embodiments, the stretching is based on the premise that most of the image is stretched below the N_{Max} input gray shade level. Since most of the mage luminance is controlled to be highest at the N_{Max} input gray shade, the luminance at the N_{Max} location may be lowered as a function of the ambient light level by increasing the N_{Max} gray shade to a new N_{MaxNew} gray shade level. As shown in FIG. 10, the ideal is to move the transfer function such that the luminance is decreased to the level appropriate to maintain display visibility at the N_{Max} gray shade. By taking such an approach, the image is less stretched under lower ambient lighting levels and a new N_{MaxNew} threshold point is utilized. The idea of this approach is to calculate a new threshold, N_{MaxNew}, based on the light sensor data and to use the new threshold value instead of N_{Max} value in the method.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A true color image enhancement compensation system comprising:
an ambient light sensor operational to measure an ambient light level;
a circuit operational to:
generate a histogram based on an input video signal;
export the histogram;
receive a gray shade look up table; and
generate an output video signal by converting a plurality of gray shades in the input video signal based on a plurality of input video luminance ratios and the gray shade look up table to determine a plurality of new output gray shade values to maintain input video color coordinates; and
a processor operational to:
receive the histogram from the circuit;
develop the gray shade look up table based on the histogram and the ambient light level;
dynamically remap the plurality of gray shades in the gray shade look up table in response to the ambient light signal to compress a first region of the plurality of gray shades and stretch a second region of the plurality of gray shades;
dynamically remap the plurality of gray shades in the gray shade look up table to correct for ambient lighting conditions; and
transfer the gray shade look up table to the circuit.

2. The true color image enhancement compensation system according to claim 1, wherein the processor includes:
a constant contrast table operational to adjust each successive gray shade of the plurality of gray shades to a constant contrast ratio.

3. The true color image enhancement compensation system according to claim 1, wherein the processor includes:
a gamma table operational to adjust each successive gray shade of the plurality of gray shades to follow an offset gamma function.

4. The true color image enhancement compensation system according to claim 1, wherein the processor includes:
a plurality of table modifiers operational to modify one of a plurality of shaping functions for the plurality of gray shades.

5. The true color image enhancement compensation system according to claim 1, wherein the processor includes:
a gray shade detection threshold operational to determine a maximum gray scale number such that a specific percentage of a plurality of pixels are above a threshold percentage.

6. The true color image enhancement compensation system according to claim 1, wherein the processor includes:
a maximum gray shade rate limiter operational to control a rate at which a breakpoint value in adjusted to a single gray shade value each time increment.

7. The true color image enhancement compensation system according to claim 1, wherein the circuit includes:
a frame rate controller operational to convert high-dynamic range video data to dithered video.

8. A true color image enhancement compensation system comprising:
an ambient light sensor operational to measure an ambient light level;
a circuit operational to:
generate a histogram based on an input video signal;
export the histogram;
receive a gray shade look up table;
dynamically remap a plurality of gray shades in the gray shade look up table using a highest remapped color to determine and maintain a plurality of input luminance ratios of a plurality of lower gray shade colors; and
generate an output video signal by converting a plurality of gray shades in the input video signal based on a plurality of input video luminance ratios and the gray shade look up table to determine a plurality of new output gray shade values to maintain input video color coordinates; and
a processor operational to:
receive the histogram from the circuit;
develop the gray shade look up table based on the histogram and the ambient light level; and
transfer the gray shade look up table to the circuit.

9. The true color image enhancement compensation system according to claim 8, wherein the circuit is further configured to:
find a gray shade maximum input value among three color values of an incoming pixel in the input video signal.

10. The true color image enhancement compensation system according to claim 9, wherein the circuit is further configured to:
lookup a multiplier value using a lookup table based on the gray shade maximum input value.

11. The true color image enhancement compensation system according to claim 10, wherein the circuit is further configured to:
lookup the highest remapped color using a transfer function based on the gray shade maximum input value.

12. The true color image enhancement compensation system according to claim 11, wherein the circuit is further configured to:
remap the plurality of gray shades based on the multiplier value and the gray shade maximum input value.

13. The true color image enhancement compensation system according to claim 12, wherein the transfer function is loadable from a source external to the circuit.

14. The true color image enhancement compensation system according to claim 12, wherein a plurality of numerators of the plurality of gray shades as remapped may be calculated prior to a right shift division to maintain an accuracy of results.

15. A true color image enhancement compensation system comprising:
an ambient light sensor operational to measure an ambient light level;
a circuit operational to:
generate a histogram based on an input video signal;
export the histogram;
receive a gray shade look up table;
dynamically remap a plurality of gray shades in the gray shade look up table using a tristimulus conversion matrix to determine a plurality of normalized gray shades based on a normalization of a highest color when an upper limit is reached; and
generate an output video signal by converting a plurality of gray shades in the input video signal based on a plurality of input video luminance ratios and the gray shade look up table to determine a plurality of new output gray shade values to maintain input video color coordinates; and
a processor operational to:
receive the histogram from the circuit;
develop the gray shade look up table based on the histogram and the ambient light level; and
transfer the gray shade look up table to the circuit.

16. The true color image enhancement compensation system according to claim 15, wherein the circuit is further operational to perform a tristimulus calculation that includes:
first convert the plurality of gray shades to a plurality of new gray shades using a first transfer table; and
second convert the plurality of new gray shades to a plurality of first intermediate gray shades using a lookup table.

17. The true color image enhancement compensation system according to claim 16, wherein the tristimulus calculation further includes:
convert the plurality of first intermediate gray shades to a second intermediate value Y using a lookup table and the tristimulus conversion matrix.

18. The true color image enhancement compensation system according to claim 17, wherein the tristimulus calculation further includes:
convert the plurality of first intermediate gray shades to a second intermediate value X and a second intermediate value Y based on the second intermediate value Y.

19. The true color image enhancement compensation system according to claim 18, wherein the tristimulus calculation further includes:
convert the second intermediate values into a plurality of third intermediate values using an inverse matrix.

20. The true color image enhancement compensation system according to claim 19, wherein the tristimulus calculation further includes:
normalize the plurality of third intermediate values.
